(19) United States
(12) Patent Application Publication
(10) Pub. No.: US 2024/0257527 A1
(43) Pub. Date: Aug. 1, 2024

(54) FREE SPACE DETECTION USING RGB-POLARIMETRIC IMAGES

(71) Applicant: GM GLOBAL TECHNOLOGY OPERATIONS LLC, Detroit, MI (US)

(72) Inventors: Michael Baltaxe, Kfar Saba (IL); Tomer Pe'er, Rishon Lezion (IL); Dan Levi, Ganei Tikvah (IL)

(73) Assignee: GM GLOBAL TECHNOLOGY OPERATIONS LLC, Detroit, MI (US)

(21) Appl. No.: 18/161,211

(22) Filed: Jan. 30, 2023

(51) Int. Cl. G06V 20/56; G06V 10/143; G06V 10/60; G06V 10/774; G06V 10/80; G06V 10/82; G06V 20/70

(52) U.S. Cl. CPC G06V 20/56; G06V 10/143; G06V 10/60; G06V 10/774; G06V 10/806; G06V 10/82; G06V 20/70; B60W 50/14; B60W 2050/146; B60W 60/001; B60W 2420/403

(57) ABSTRACT

A free space estimation and visualization system for a host vehicle includes a camera configured to collect red-green-blue (“RGB”)-polarimetric image data of drive environs of the host vehicle, including a potential driving path. An electronic control unit (“ECU”) receives the RGB-polarimetric image data and estimates free space in the driving path by processing the RGB-polarimetric image data via a run-time neural network. Control actions are taken in response to the estimated free space. A method for use with the visualization system includes collecting RGB and lidar data of target drive scenes and generating, via a first neural network, pseudo-labels of the scenes. The method includes collecting RGB-polarimetric data via a camera and thereafter training a second neural network using the RGB-polarimetric data and pseudo-labels. The second neural network is used in the ECU to estimate free space in the potential driving path.

### INTRODUCTION

Autonomous-controlled vehicles rely heavily on computer vision capabilities developed through machine learning methods. For example, an onboard controller of an autonomous vehicle may use computer vision capabilities to accurately estimate the roadway and its surrounding drive environment. Using a specialized suite of onboard sensors, the vehicle controller is able to estimate the road surface for path planning and route execution, as well as potential obstacles such as other vehicles, pedestrians, curbs, sidewalks, trees, and buildings. The controller, upon receiving image data and other information from the onboard sensor suite, may apply machine learning techniques to estimate the roadway and drive environs, with this information thereafter used to control a drive event.

In general, the image data collected by the onboard sensor suite includes pixel data corresponding to drivable surface area or free space. Free space in a given image is typically estimated as a binary segmentation of the collected image, with image segmentation techniques being performed to separate the drivable surface area from the surface area of non-drivable surfaces. The use of color video alone for the purpose of detecting free space is suboptimal for various reasons. For instance, a paved road surface will often use similar paving materials and colors as other structures or features in the image, such as a curb or a sidewalk. As a result, one surface is often easily confused for another, which in turn may adversely affect performance of onboard free space estimation and path planning functions.

### SUMMARY

The solutions described herein are collectively directed toward improving the overall drive experience of a host vehicle using combined red, green, blue (“RBG”)-polarimetric data, with the host vehicle exemplified herein as an autonomously controlled motor vehicle. Other ground-based mobile platforms requiring the accurate detection of free space may also benefit from the present teachings, and therefore the disclosure is not limited to motor vehicles.

Free space detection functions performed as described herein involve locating and identifying drivable surface areas within an image frame in relation to the host vehicle, and thus is an essential input to automated path planning and decision making. As noted above, RGB data alone is suboptimal when attempting to identify free space in a collected image. While lidar is a possible data source for acquiring identifying geometric information for the purpose of distinguishing a drivable surface from other surfaces or objects in an image, the incorporation of lidar sensors into the architecture of the host vehicle is a relatively expensive proposition. The present approach addresses this potential problem using combined RGB-polarimetric data as set forth in detail below.

In particular, an aspect of the disclosure includes a free space estimation and visualization system for use with a host vehicle. An embodiment of the system includes a camera and an electronic control unit (“ECU”). The camera is configured to collect RGB-polarimetric image data of drive environs of the host vehicle, including a potential driving path thereof. The ECU, which is in communication with the camera, is configured to receive the RGB-polarimetric image data from the camera and estimate an amount of free space in the potential driving path as estimated free space. This action includes processing the RGB-polarimetric image data via a run-time neural network. The ECU then executes a control action aboard the host vehicle in response to the estimated free space.

In one or more embodiments, the ECU calculates a feature set using the RGB-polarimetric image data, and then communicates the feature set to the run-time neural network as an input data set. The input data set in turn is characterized by an absence of lidar data.

The feature set may have six set elements determined as a concatenation of the RGB data, angle of linear polarization (“AoLP”) data, and degree of linear polarization (“DoLP”) data from the camera. For instance, the six set elements could include sin(2·AoLP), cos(2·AoLP), 2·DolP−1, 2·R−1, 2·G−1, and 2·B−1.

The host vehicle in a possible implementation is a motor vehicle having a vehicle body, in which case the camera is connected to the vehicle body.

The ECU in one or more embodiments of the disclosure is in communication with a path planning control module of the host vehicle. In such an implementation, the path planning control module is configured to plan a drive path of the host vehicle as at least part of the control action.

An aspect of the disclosure includes the ECU being in communication with a display screen and configured to display a graphical representation of the estimated free space on the display screen.

A method is also disclosed herein for estimating free space aboard a host vehicle. The method in accordance with one or more embodiments includes collecting RGB data and lidar data of a target drive scene using an RGB camera and a lidar camera, respectively, and then generating, via a first neural network of a training computer, pseudo-labels as a ground truth of the target drive scene. The method also includes collecting RGB-polarimetric data via a camera, training a second neural network via the training computer using the RGB-polarimetric data and the pseudo-labels, and using the second neural network in an ECU of the host vehicle as a run-time neural network to estimate an amount of free space in a potential driving path of the host vehicle as estimated free space.

A host vehicle is also disclosed herein having a vehicle body, road wheels, a camera, and an ECU. The camera is configured to collect RGB-polarimetric image data of drive environs of the host vehicle, including a potential driving path thereof. The ECU is configured to receive the RGB-polarimetric image data from the camera, estimate an amount of free space in the potential driving path as estimated free space, including processing the RGB-polarimetric image data via a run-time neural network, and execute a control action aboard the host vehicle in response to the estimated free space.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of an autonomous vehicle equipped with free space estimation and visualization systems in accordance with the present disclosure.

FIG. 2 is a flow diagram of an embodiment of the free space estimation and visualization systems of FIG. 1.

FIGS. 3 and 4 are flow diagrams describing a training/offline stage of the free space estimation system shown in FIG. 2.

FIGS. 5 and 6 are flow diagrams describing a run-time/online stage of the estimation system shown in FIG. 2.

FIG. 7 is a representative illustration of free space within a driving environ of a host vehicle in accordance with an aspect of the disclosure.

The appended drawings are not necessarily to scale, and may present a simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

The present automated solutions are operable for detecting free space drive environs or drive scene of an automated host vehicle. The scene is ascertained using combined visible spectrum/red-green-blue (“RGB”)-polarimetric image data, deep learning, and multi-modal data as described in detail herein. In general, the technical solutions presented herein utilize two neural networks in different capacities: (1) an offline/training model, and (2) an online/run-time model. The training neural network, referred to herein as first neural network NN₁ for clarity, is used offline to generate pseudo-labels on a training dataset, with the training dataset including lidar data, RGB data, and polarimetric data. Inputs to the first neural network (NN₁), however, are limited to RGB data and lidar data.

The pseudo-labels generated by the training model, i.e., neural network NN₁, are then used, still offline, to train a second neural network (NN₂). The second neural network (NN₂) for its part receives RGB-polarimetric data as its data input. That is, unlike the first neural network (NN₁) used solely offline for training purposes, the second neural network (NN₂) is also used online, i.e., aboard the host vehicle during a drive operation. In doing so, the second neural network (NN₂) does not receive or use lidar data to infer free space as part of the present strategy. As a result, the host vehicle as contemplated herein is characterized by an absence of a lidar sensor.

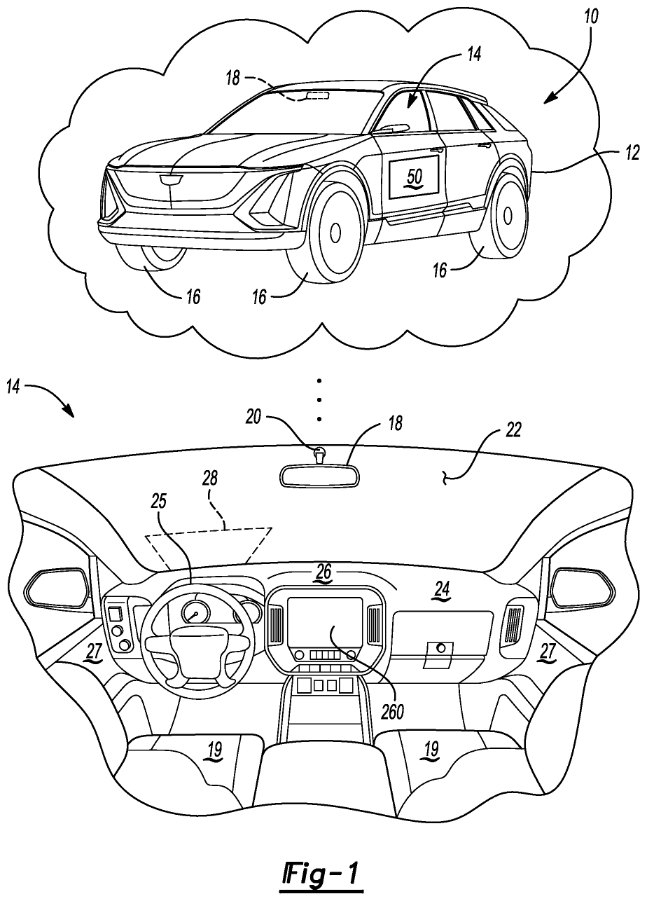

Referring to FIG. 1, an autonomously-controlled mobile system (“host vehicle”) 10 includes a vehicle body 12 defining a vehicle interior 14. Solely for illustrative consistency, the host vehicle 10 is described herein as being embodied as an autonomously-controlled motor vehicle, e.g., a passenger vehicle as shown. However, the present teachings may be applied in other mobile systems having a ground-based drive path that is not predefined or restricted, e.g., by rails, tracks, or the like. For example, the solutions described in detail below may be used with wheeled or tracked transport vehicles, farm equipment, trucks, delivery vehicles, mobile platforms, etc. Solely for illustrative consistency, the host vehicle 10 of FIG. 1 will be described below as a representative motor vehicle without limiting the disclosure to such an embodiment.

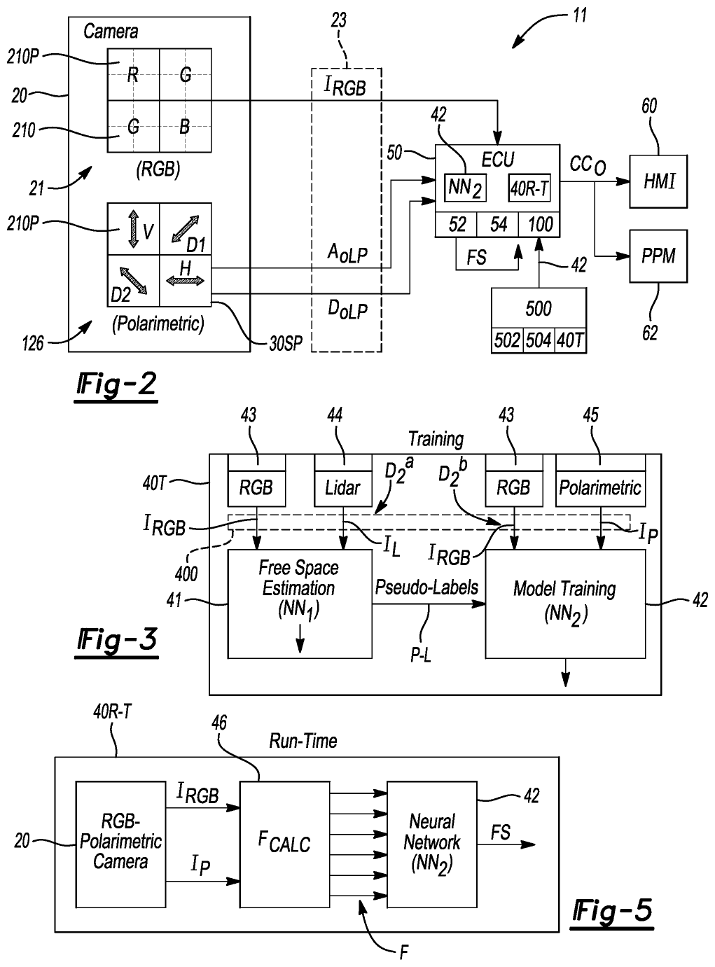

The host vehicle 10 is equipped with an electronic control unit (“ECU”) 50. The ECU 50 in turn is used as part of a free space estimation and visualization (“FSEV”) system 11, a representative example embodiment of which is depicted in FIG. 2 and described below. The ECU 50 is configured via software programming and the use of suitable hardware to estimate and visualize the surrounding drive environs of the host vehicle 10. As used herein, the term “drive environs” refers to a potential/candidate set of drivable surface area in an imaged drive scene for consideration by the ECU 50 when planning a drive path and/or when communicating the drive path to one or more passengers (not shown) seated within the vehicle interior 14.

Drive environs that are estimated and visualized as set forth herein may encompass drivable surfaces in proximity to the host vehicle 10, including paved, semi-paved, or unpaved roads, driveways, and parking lots, as well as excluded/non-drivable surfaces such as sidewalks, curbs, buildings, bodies of water, forests, and fields. More specifically, the ECU 50 is configured to use RBG-polarimetric data for the purpose of identifying free space in such drive environs, with an ultimate goal of improving the accuracy of drive path planning processes while reducing hardware costs associated with this task.

Further with respect to the exemplary host vehicle 10, the vehicle body 12 is connected to one or more road wheels 16, with a typical four wheel configuration shown in FIG. 1. At least one of the road wheels 16 is powered by a powertrain system (not shown), e.g., an electric traction motor and/or an internal combustion engine and associated torque transfer mechanisms, to provide torque to the road wheels 16 at levels sufficient for propelling the host vehicle 10. Depending on the particular configuration of such a powertrain system, the host vehicle 10 of FIG. 1 could be variously embodied as a battery electric vehicle, a hybrid electric vehicle, a plug-in hybrid electric vehicle, an extended-range electric vehicle, a fuel cell vehicle, a gasoline, diesel, or a compressed natural gas or biofuel-powered vehicle in different constructions. The vehicle body 12 for its part may vary with the configuration of the autonomous vehicle 10, for instance as a sedan, coupe, pickup truck, crossover, sport utility vehicle, or other body style.

The vehicle interior 14 of the host vehicle 10 may be equipped with one or more rows of vehicle seats 19, with two of the vehicle seats 19 illustrated in FIG. 1 adjacent driver and passenger doors 21 and aft of a windshield 22 and an instrument panel 24. A rear view mirror assembly 18 may be mounted to the windshield 22, with one or more cameras 20 connected to the windshield 22 and/or other suitable surfaces of the host vehicle 10 in different embodiments.

The vehicle interior 14 is also equipped with various driver input devices, such as a steering wheel 25 and brake and accelerator pedals (not shown), etc. For the purpose of facilitating interaction of occupants of the host vehicle 10, the instrument panel 24 may be equipped with a center stack 26 having a display screen 260. In one or more embodiments, the host vehicle 10 may also be equipped with a heads-up display (“HUD”) 28, with the HUD 28 being configured for projecting information onto the windshield 22 as shown, or via a separate display screen (not shown) situated on the instrument panel 24. Either or both of the HUD 28 or the display screen 260 may ultimately display a graphical representation of the estimate free space, e.g., as a color view of the drive scene ahead of the host vehicle 10, with identified free space in the drive scene incorporated into the drive path planning function of the ECU 50.

Referring to FIG. 2, the ECU 50 configured as described herein relies on the availability and use of RGB-polarimetric data from the camera(s) 20 for the purpose of identifying drivable surface area in the drive environs of the host vehicle 10. Such drivable area is referred to as “free space” as noted above, the presence or absence of which is determined from two-dimensional (“2D”) image data 23 collected by the camera(s) 20.

This multi-mode capability of the camera 20 is represented as a color pixel block 21 constructed of red (“R”), green (“G”), and blue (“B”) image pixels 210. Each image pixel 210 may have four or more constituent sub-pixels 210P, for a total of sixteen or more pixel calculation units, as appreciated in the art. Arrow I_{RGB} represents the RGB color information contained in the 2D image data 23 as provided to the ECU 50 as part of the present strategy.

As noted above, the camera 20 is configured herein as an RGB-polarimetric imaging device. As such, the camera 20 also collects polarization data of the imaged drive scene, with the polarization data synchronized in time with the RGB data. In FIG. 2, the polarization data is represented as polarized pixel block 126 having four of the sub-pixels or pixel calculation units 210P. Each of the pixel calculation units 210P has a corresponding polarity direction as indicated by polarization arrows V, D1, D2, and H representing vertical, first and second diagonal, and horizontal polarities, respectively. The 2D image data 23 communicated to the ECU 50 by the camera 20 thus includes RGB data and polarimetry data, with the latter being in the form of an angle of linear polarization (“AoLP”) and a degree of polarization (“DoLP”).

As will be appreciated by those of ordinary skill in the art, polarimetry pertains to the measurement and interpretation of a polarization state of transverse waves, such as the light waves considered in the present application. Polarimetry is often used to study properties of interest in different materials, as well as the presence or absence of certain substances therein. For instance, ambient sunlight falling incident upon a road surface will reflect off of the surface to some extent. The ECU 50 thus determines the polarization state of the reflected portion of the incident sunlight and uses this information to inform decisions and control actions aboard the host vehicle 10 of FIG. 1.

For example, the ECU 50 may use the polarization state to ascertain scene information, including the orientation and material properties of the surface, the viewing direction of the camera 20, the illumination direction of incident sunlight, etc. The polarization state in turn is measured by the camera 20 by passing reflected light through a set of polarizing filters (present on top of each of the subpixels 210P) of the camera 20, and thereafter measuring light intensity as the light is transmitted from the polarizing filter. The amount of transmitted light depends on the angle between the polarizing filter and the oscillation plane of the electrical field of incident light, and thus can be measured and used by associated processing hardware of the camera 20 to determine the polarization state.

In order to perform the disclosed estimation and visualization functions when identifying free space in the 2D image data 23 of FIG. 2, one or more processors 52 of the ECU 50 are configured to execute instructions 100 to implement estimation and visualization methods. The instructions 100 and corresponding method may be implemented as control logic or computer-readable instructions from memory 54. A second/run-time neural network (NN₂) 42 is recorded in memory 54 and used herein when analyzing a drive scene and performing various control actions aboard the host vehicle 10 as described below. Such instructions may be stored in the memory 54, which may include tangible, non-transitory computer-readable storage medium, e.g., magnetic media or optical media, CD-ROM, and/or solid-state/semiconductor memory, such as various types of RAM or ROM. The term “controller” and related terms used herein such as control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.).

Various other hardware in communication with the ECU 50 may include, e.g., input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Non-transitory components of the memory 54 are capable of storing machine-readable instructions in the form of one or more software or firmware programs or routines, combinational logic circuit(s), input/output circuit(s) and devices, signal conditioning and buffer circuitry and other components that can be accessed by one or more processors 52 to provide a described functionality.

The FSEV system 11 for the host vehicle 10 therefore includes the camera 20 in addition to the ECU 50 and its processor 52 and memory 54. The camera 20 is configured to collect RGB-polarimetric image data of drive environs of the host vehicle 10 as noted above, including a potential driving path of the host vehicle 10. The ECU 50 as described above is configured to receive the RGB-polarimetric image data from the camera 20, and to estimate an amount of free space in the potential driving path as estimated free space, including processing the RGB-polarimetric image data via a run-time neural network. The ECU 50 then executes a control action aboard the host vehicle 10 in response to the estimated free space.

In terms of possible control actions, the integral or connected computer architecture of the ECU 50 shown in FIG. 2 may also include a human-machine interface (“HMI”) 60, which may include either or both of the above-described HUD 28 and/or the display screen 260 of FIG. 1 or another suitable device. Additionally, the ECU 50 may include or may be in communication with a Path Planning Module (“PPM”) 62, such that the ECU 50 communicates the estimated free space to the PPM 62 as a possible control action or a portion thereof. The PPM 62 may be embodied as one or more processors or electronic control modules akin to the processor 52 or sharing processing capabilities thereof, with the PPM 62 being configured to auto-generate a driving path that the host vehicle 10 will ultimately travel on during a drive event. Such a path utilizes identified free space (arrow FS) determined as set forth herein to separate drivable surface area from non-drivable surface area.

The ECU 50 thus transmits output signals (arrow CC_{O}) to the HMI 60 and the PPM 62 as part of this process, with the output signals (arrow CC_{O}) including the identified free space in the 2D image data 23 of FIG. 2 and the drive path associated therewith as determined by the PPM 62. To perform these functions, machine learning techniques are applied during two distinct performance stages, i.e., (1) off-line training, i.e., offboard of the host vehicle 10, and (2) on-line/run-time execution aboard the host vehicle 10. Both of these performance stages will now be described with reference to FIGS. 3-6.

OFFLINE TRAINING: turning now to FIG. 3 (“Training”), a training block 40T is shown that is performed offline via an offline training computer 500 in the form a digital computer device or devices having one or more processors 502 and memory 504. The hardware construction of the processor 502 and memory 504 is analogous to the processor 52 and memory 54 of the ECU 50 as described above. Lidar and RGB modalities of a training data set 400 are provided to a first neural network (NN₁) 41 (“Free Space Estimation”) of the training computer 500 for the ultimate purpose of training the aforementioned second neural network (NN₂) 42 (“Model Training”) on the RGB and polarimetric modalities of the same dataset. The first neural network 41 is used solely offline, i.e., via the training computer 500 apart from the host vehicle 10, while the second neural network 42, once properly trained via the first neural network 41, is used online or during run-time/operation of the host vehicle 10. Thus, the memory 54 of the ECU 50 is programmed with the second neural network 42 as part of its construction, as shown schematically in FIG. 2.

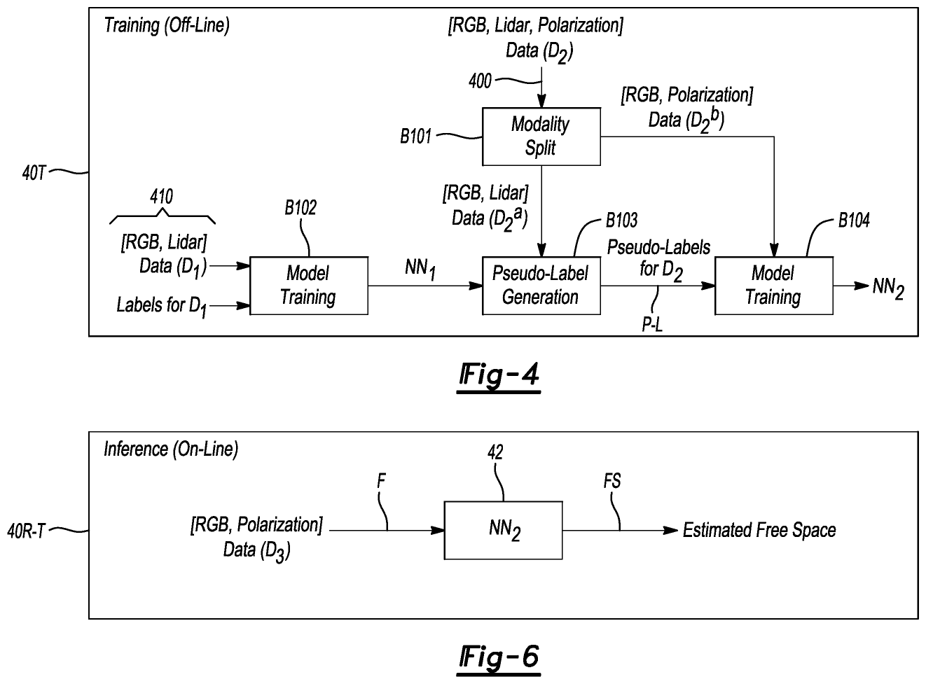

In general, the training block 40T of FIG. 3 may be implemented by a manufacturer of the host vehicle 10 or the ECU 50 via the training computer 500 to ultimately provide the ECU 50 with the capability of distinguishing free space in the image pixel data forming the training data set 400. To this end, the first neural network 41 receives RGB data (arrow I_{RGB}) and lidar data (I_{L}) from corresponding RGB and lidar sensors 43 and 44, respectively. The first neural network 41 is previously pre-trained on a different dataset 410 (see FIG. 4) which includes training labels but no polarimetric data. The first neural network 41 is then iteratively refined to yield high quality estimations by manually creating labels for the training dataset 400 and re-training the first neural network 41 with each iteration. This way, the first neural network 41 is eventually able to output an accurate estimation of free space on the full training data set 400, with little manual intervention.

This estimated free space information is provided as an input to the training process of the second neural network 42 as pseudo-labels (P-L), with the second neural network 42 receiving only color image data (arrow I_{RGB}) and polarimetric data (I_{P}) as inputs within the training block 40T. Such data could be provided by a single integrated sensor, e.g., the camera 20 of FIG. 1, or as separate RGB and polarimetric sensors 43 and 45, respectively. The pseudo-labels (P-L) replace the traditional labels used in the optimization method to follow, allowing the second neural network 42 to be trained using standard methods. The desired end result of operating the training block 40T offline is a fully trained embodiment of the second neural network 42, which a manufacturer could then load into memory 54 of the ECU 50 for production versions of the host vehicle 10 of FIG. 1.

The training stage of FIG. 3 is shown in further detail in FIG. 4 (“Training (Off-line)”) in terms of component steps or logic blocks, e.g., algorithms, code segments, or subroutines executed by training computer 500 using the training module 40T of FIG. 3. At block B101 (“Modality Split”), data set 400 (also labeled D₂) consisting of time-synchronized RGB, lidar, and polarization data is fed into a modality splitting routine to separate the RGB data and lidar data (arrows I_{RGB} and I_{L} of FIG. 3) into a data set D₂^{a}, with the RGB data and polarization data forming a separate data set D₂^{b}. Block B101 therefore includes transmitting the different modal data sets D₂^{a} and D₂^{b} to blocks B103 and B104, respectively.

Block B102 (“Model Training”) of FIG. 4 includes receiving the data set 410 of FIG. 4 as a data set D₁ (“[RGB, Lidar] Data (D₁)”) which includes RGB and lidar data but which does not include polarimetric data. This dataset 410, which comes from scenes different from those included in dataset 400, is used to train the first neural network 41. For this, block B102 also includes receiving labels (“Labels for D₁”) for the corresponding image pixels in such data, which may be a manual process or one supported by machine vision capabilities in different implementations. Block B102 then outputs the first neural network NN₁ as a trained model to block B103.

Block B103 (“Pseudo-Label Generation”) includes generating pseudo-labels (P-L) for use in training the second neural network 42 of FIG. 3. Pseudo-label generation occurs in response to the first neural network 41 and the data set D₂^{a} from block B101, i.e., the RGB and lidar data. As appreciated in the art, machine learning is typically one of four main types: (i) supervised, (ii) unsupervised, (iii) semi-supervised, and (iv) reinforcement. Of these, supervised and semi-supervised learning use data labels.

Pseudo-labeling as performed in block B103 starts by estimating free space on the data set D₂^{a}. This occurs via the first neural network 41. A small set of these estimations are then manually refined, and the first neural network 41 is fine-tuned on its own estimations and the refined labels to improve accuracy. This process is iterated several times until the automatic estimations of the first neural network 41 are good enough, e.g., relative to a predetermined objective standard. The estimations are then regarded as the pseudo-labels (P-L).

Block B104 (“Model Training”) of FIG. 4 entails training the second neural network 42 of FIG. 3. This occurs using the data set D₂^{b} from block B101 and the pseudo-labels for data set D₂ (arrow P-L) from block B103. This process is analogous to the process for training the first neural network 41 in block B102, but it omits use of the lidar data as an input in favor of polarimetric data. The output of training module 40T is therefore a fully trained model in the form of the second neural network (NN₂) 42. Block B104 thus calculates a feature set (F), which is used as an input to the second neural network 42.

RUN-TIME: FIGS. 5 and 6 together describe run-time implementation of the second neural network 42 aboard the host vehicle 10 of FIG. 1. A run-time module 40R-T is used by the ECU 50 aboard the host vehicle 10 for this purpose. As shown in FIG. 5 (“Run-Time”), the camera 20 of FIG. 1 collects and provides the RGB data (arrow I_{RGB}) and the polarimetric data (arrow I_{P}) to a processing block (“F_{CALC}”) 46. The processing block 46 in turn calculates a feature set (F) as an input to the second neural network (NN₂) 42. The same feature set (F) used for training in block B104 of FIG. 4 is used for run-time performance.

As a representation of the polarimetric data, the ECU 50 may use the AoLP, which is in the range (0°-180°), and the DoLP with its range (0-1). The feature representation used as an input to the second neural network 42 may be a concatenation of AoLP, DoLP, and the RGB data. Thus, a representative six-element feature set (F)=[F1, F2, F3, F4, F5, F6] could be calculated, where F1=sin(2·AoLP), F2=cos(2·AoLP), F3=2·DolP−1, F4=2·R−1, F5=2·G−1, and F6=2·B−1. The data in such a feature set (F) would fall in the range [−1, 1], and thus circular ambiguity in the AoLP is surmounted where 0° is equivalent to 180°.

The feature set (F) is communicated to the run-time neural network, i.e., the second neural network 42, as an input data set that is characterized by an absence of lidar data. That is, the second neural network 42 shown in FIG. 5 receives the feature set (F) as an input data set and identifies the free space (arrow FS) as an output value. Referring briefly to FIG. 6, run-time block 40R-T operates using the RGB data (arrow I_{RGB}) and the polarimetry data (I_{P}), which together form real-time data D₃, i.e., the image data 23 from the camera 20 as shown in FIG. 2. The estimated free space (arrow FS) determined by the second neural network 42, itself acting as the online/run-time model aboard the host vehicle 10, is thereafter usable by the ECU 50 or other systems aboard the host vehicle 10, e.g., when route planning or when performing enhanced interactions with the driver via a colorized display presented on the optional HUD 28 of FIG. 1.

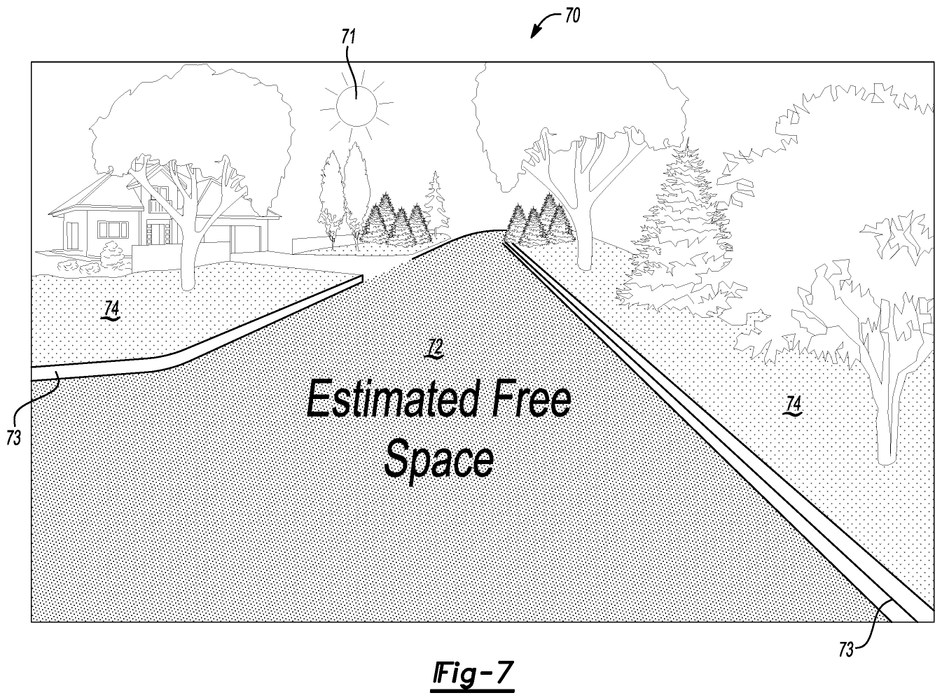

Referring now to FIG. 7, a representative drive scene 70 as visualized by the FSEV system 11 of FIG. 2 may be displayed on the display screen 260 and/or the HUD 28 of FIG. 1 to inform an occupant of the vehicle interior 14 as to drivable surface area in the drive scene 70. To this end, the ECU 50 could shade, colorize, outline, or otherwise accentuate the estimated free space 72 within the drive scene 70 relative to a surrounding environment, e.g., curbs 73 and unpaved/undrivable terrain 74 surrounding the estimated free space 72 such as grass, woods, etc.

As set forth above, when incident light from the sun 71 reflects off of a surface, the reflected light has an identifiable polarized state that the ECU 50 of FIGS. 1 and 2 uses to distinguish the free space 72 from its surroundings. Moreover, the ECU 50 is able to inform other devices such as the PPM 62 of FIG. 2 as to the location of the free space 72. A possible control action that may be taken by the ECU 50 therefore includes planning and decision making processes performed by the PPM 62 of FIG. 2 during autonomous driving as, in which case the exemplary drive scene 70 of FIG. 7 may exist solely in the memory 54 of the ECU 50. The ECU 50 could also detect objects on a roadway that do not correspond to standard classes trained on autonomous vehicle detection systems, e.g., cars, pedestrians, bicycles, etc. As appreciated in the art, free space is typically used as a general object detector as opposed to its determination and use as set forth herein.

When communicating with a driver or other passengers of the host vehicle 10 of FIG. 1, the ECU 50 could also selectively display the drive scene 70 of FIG. 7 via the HUD 28 and/or the display screen 260 of FIG. 1. The ECU 50 could in some embodiments enhance or accentuate edges of the free space 72 in the drive scene 70, such as by overlaying lane or road boundaries or obstacles with color-coded lines or other graphics akin to trajectory lines used to enhance backup camera displays. The ECU 50 could likewise create a “bowl view” or 360° depiction of the drive environs with the road surface properly aligned, along with other possible control actions when interacting with the driver/passengers of the host vehicle 10.

In general, therefore, a method for use with the FSEV system 11 for the host vehicle 10 includes collecting RGB and lidar data of a target drive scene using an RGB camera and a lidar camera, respectively, generating, via the first neural network 41, pseudo-labels (P-L) as a ground truth of the target drive scene, and collecting RGB-polarimetric data via the camera 20. The method also includes training the second neural network 42 using the RGB-polarimetric data and the pseudo-labels, using the second neural network 42 in the ECU 50 of the host vehicle 10 as a run-time neural network to estimate an amount of free space in a potential driving path of the host vehicle 10 as estimated free space (FS), including processing additional RGB-polarimetric image data via the second neural network 42, and executing a control action aboard the host vehicle 10 in response to the estimated free space (FS).

As will be appreciated by those skilled in the art having the benefit of the foregoing disclosure, in order to perform the method, the host vehicle 10 of FIG. 1 is equipped with the camera 20 and its RGB-polarimetric capabilities to estimate free space in an imaged drive scene, e.g., the free space 72 of the representative drive scene 70 shown in FIG. 7. RGB and lidar data is used to train the first neural network 41 of FIG. 3 as weak supervision to extract free space pseudo-labels (P-L) of FIG. 3. Aboard the host vehicle 10, the ECU 50 then uses RGB-polarimetric data as an input to the second neural network 42 (FIG. 3) to estimate free space. The second neural network 42 is trained using, as supervision, the pseudo-labels (P-L) calculated during training from the RGB and lidar data.

The ECU 50 thereafter estimates free space using the trained second neural network 42 using the RGB-polarimetric data as its input. Thus, the ECU 50 and the accompanying methodology as described above is characterized by an absence of the use of lidar data during run-time execution. As a result, production models of the host vehicle 10 of FIG. 1 need not be equipped with relatively expensive lidar sensors. Such vehicles could instead use lower-cost, commercially-available RGB-polarimetric cameras such as the camera 20 described above. The present solutions are therefore available as an alternative to equipping the host vehicle 10 with a lidar sensor. These and other attendant benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A free space estimation and visualization system for a host vehicle, comprising:
a camera configured to collect red-green-blue (“RGB”)-polarimetric image data of drive environs of the host vehicle, including a potential driving path of the host vehicle; and
an electronic control unit (“ECU”) in communication with the camera and configured to:
receive the RGB-polarimetric image data from the camera;
estimate an amount of free space in the potential driving path as estimated free space, including processing the RGB-polarimetric image data via a run-time neural network; and
execute a control action aboard the host vehicle in response to the estimated free space.

2. The system of claim 1, wherein the ECU is configured to calculate a feature set using the RGB-polarimetric image data, and to communicate the feature set to the run-time neural network as an input data set, the input data set being characterized by an absence of lidar data.

3. The system of claim 2, wherein the feature set has six set elements determined as a concatenation of RGB data, AoLP data, and DoLP data from the camera.

4. The system of claim 3, wherein the six set elements include sin(2·AoLP), cos(2·AoLP), 2·DolP−1, 2·R−1, 2·G−1, and 2·B−1.

5. The system of claim 1, wherein the host vehicle is a motor vehicle having a vehicle body, and wherein the camera is connected to the vehicle body.

6. The system of claim 1, wherein the ECU is in communication with a path planning module of the host vehicle, and is configured to provide the estimated free space to the path planning module as at least part of the control action.

7. The system of claim 1, wherein the ECU is in communication with a display screen and configured to display a graphical representation of the estimated free space on the display screen.

8. A method for use with a free space estimation and visualization system, comprising:
collecting red-green-blue (“RGB”) data and lidar data of a target drive scene using an RGB camera and a lidar sensor, respectively;
generating, via a first neural network of a training computer, pseudo-labels of the target drive scene;
collecting RGB-polarimetric data via an RGB-polarimeric camera;
training a second neural network of the training computer using the RGB-polarimetric data and the pseudo-labels;
using the second neural network in an electronic control unit (“ECU”) of the host vehicle as a run-time neural network to estimate an amount of free space in a potential driving path of the host vehicle as estimated free space, including processing additional RGB-polarimetric image data via the run-time neural network; and
executing a control action aboard the host vehicle in response to the estimated free space.

9. The method of claim 8, further comprising:
calculating a feature set using the RGB-polarimetric image data; and
communicating the feature set to the run-time neural network as an input data set, wherein the input data set is characterized by an absence of lidar data.

10. The method of claim 9, wherein calculating the feature set using the RGB-polarimetric image data includes calculating the feature set with six set elements as a concatenation of RGB data, AoLP data, and DoLP data from the camera.

11. The method of claim 10, wherein calculating the feature set with six set elements includes calculating sin(2·AoLP), cos(2·AoLP), 2·DolP−1, 2·R−1, 2 G−1, and 2·B−1 as the six claim elements.

12. The method of claim 9, wherein the host vehicle is a motor vehicle having a vehicle body, the camera is a body-mounted RGB-polarimetric camera connected to the vehicle body, and collecting the RGB-polarimetric data via the body-mounted RGB-polarimetric camera.

13. The method of claim 9, wherein the ECU is in communication with a path planning control module of the host vehicle, the method further comprising:
planning a drive path of the host vehicle as at least part of the control action.

14. The method of claim 9, wherein the ECU is in communication with a display screen, the method further comprising:
displaying a graphical representation of the estimated free space on the display screen.

15. A host vehicle, comprising:
a vehicle body;
road wheels connected to the vehicle body; and
a free space estimation and visualization (“FSEV”) system including:
a camera connected to the vehicle body and configured to collect red-green-blue (“RGB”)-polarimetric image data of drive environs of the host vehicle, including a potential driving path thereof, and
an electronic control unit (“ECU”) in communication with the camera and configured to:
receive the RGB-polarimetric image data from the camera;
estimate an amount of free space in the potential driving path as estimated free space, including processing the RGB-polarimetric image data via a run-time neural network; and
execute a control action aboard the host vehicle in response to the estimated free space.

16. The host vehicle of claim 15, wherein the ECU is configured to calculate a feature set using the RGB-polarimetric image data, and to communicate the feature set to the run-time neural network as an input data set, the input data set being characterized by an absence of lidar data.

17. The host vehicle of claim 16, wherein the feature set has six set elements determined as a concatenation of RGB data, AoLP data, and DoLP data from the camera.

18. The host vehicle of claim 17, wherein the six set elements include sin(2·AoLP), cos(2·AoLP), 2·DolP−1, 2·R−1, 2·G−1, and 2·B−1.

19. The host vehicle of claim 15, further comprising:
a path planning module in communication with the ECU, wherein the ECU is configured to communicate the estimated free space to the path planning module as part of the control action, and wherein the path planning module is configured to plan a drive path of the host vehicle in response to the estimated free space.

20. The host vehicle of claim 15, further comprising:
a display screen in communication with the ECU, wherein the ECU is configured to display a graphical representation of the estimated free space on the display screen as at least part of the control action.
